(19) United States
(12) Patent Application Publication
(10) Pub. No.: US 2008/0049206 A1
(43) Pub. Date: Feb. 28, 2008

(54) ILLUMINATION SYSTEM WITH A DETECTOR FOR REGISTERING A LIGHT INTENSITY

(75) Inventor: Jens Ossmann, Aalen (DE)

Correspondence Address: FISH & RICHARDSON PC, P.O. BOX 1022, MINNEAPOLIS, MN, 55440-1022, US

(73) Assignee: CARL ZEISS SMT AG, Oberkochen (DE)

(21) Appl. No.: 11/844,002

(22) Filed: Aug. 23, 2007

Related U.S. Application Data
(63) Continuation-in-part of application No. PCT/EP07/06520, filed on Jul. 23, 2007.
(60) Provisional application No. 60/823,405, filed on Aug. 24, 2006.

(30) Foreign Application Priority Data
Aug. 24, 2006 (DE) 10 2006 039 760.6

(51) Int. Cl. G03B 27/74

(52) U.S. Cl. 355/68

(57) ABSTRACT

Illumination systems for microlithography projection exposure apparatuses, as well as related systems, components and methods are disclosed.

### CROSS-REFERENCE TO RELATED APPLICATIONS

This application claims priority under 35 U.S.C. §119(e)(1) to U.S. Ser. No. 60/823,405, filed Aug. 24, 2006. This application claims priority under 35 U.S.C. §119 to German Application Serial No. 10 2006 036 760.6, filed Aug. 24, 2006. This application is a continuation-in-part of claims priority under 35 U.S.C. §120 to International Application Serial No. PCT/EP2007/006520, filed Jul. 23, 2007. Each of these applications is hereby incorporated by reference.

### FIELD

The disclosure relates to illumination systems for microlithography projection exposure apparatuses, as well as related systems, components and methods.

### BACKGROUND

EUV lithography is known. In general, the image quality in EUV lithography can depend on the projection objective and the illumination system.

### SUMMARY

The disclosure relates to illumination systems for microlithography projection exposure apparatuses, as well as related systems, components and methods.

In one aspect, the disclosure generally provides an illumination system that is configured configured to be used in a microlithography projection exposure apparatus. The illumination system is configured to pass light therethrough during use. The illumination system includes an element configured so that, during use, the element can change a first illumination in the exit pupil plane of the illumination system to a second illumination. The illumination system also includes a detector configured so that, during use, the detector can detect the light. The illumination system further includes a device configured so that, during use, the device receives a light intensity signal of the detector. Dependent on the light intensity signal, the device produces a signal that can be used to adjust a scanning speed of a light-sensitive object in an image plane of the microlithography projection exposure apparatus.

In another aspect, the disclosure generally provides a microlithography exposure apparatus that includes an illumination system as described in the preceding paragraph, and a projection objective. The projection objective is configured to project an image of an object arranged in the object plane of the illumination system into the image plane of the projection objective.

In a further aspect, the disclosure generally provides a method that includes measuring a light energy in an illumination system that is incorporated in a microlithography projection exposure apparatus. The method also includes changing the illumination in a pupil plane of the illumination system. The method further includes, after changing the illumination in the pupil plane of the illumination system, measuring a light energy in the illumination system. In addition, the method includes forming a differential signal that represents a difference in light energy measured before and after the change of the illumination in the pupil plane of the illumination system. The method also includes, based on the differential signal, setting a scanning speed of a light sensitive object in the image plane of a projection objective that is incorporated in the microlithography projection exposure apparatus.

In an additional aspect, the disclosure generally provides a method that includes providing a first set of measured values by measuring a light energy for different illuminations in an exit pupil plane of an illumination system that is incorporated in a microlithography projection exposure apparatus. The method also includes storing the first set of measured values as calibration values in a regulating unit, and, after storing the calibration values, forming a second set of measured values by measuring the light energy via a detector. The method also includes comparing the second set of measured values to the stored calibration values. In addition, the method includes, based on the comparison, adjusting a scanning speed of a light-sensitive object in an image plane of a projection objective that is incorporated in the microlithography projection exposure apparatus.

Losses of light have among other things the consequence that the scanning speed of the projection exposure apparatus becomes relatively slow, because the exposure of a light-sensitive coating, for example a photoresist, always requires a certain amount of light. If a lesser amount of light per unit of time is available, for example because light pulses of the light source are blocked out, the scanning speed of the microlithography projection apparatus will inevitably become slower.

In some embodiments, even when an adjustment is made to the illumination in the exit pupil (e.g., when changing the degree of coherence or changing the setting), the amount of light intensity (e.g., integrated light intensity) can remain unchanged in the image plane where the wafer is arranged that is to be exposed. In certain embodiments, losses of light are reduced (e.g., minimized).

In some embodiments, the illumination system includes at least one detector configured to detect light from the light source. The detector can be arranged before, next to, or behind an element for changing the illumination in the exit pupil plane. The illumination system can further include a device which receives the light intensity signal and, dependent on the light intensity signal, sets a control signal for the scanning speed of a light-sensitive object. A device of this type is referred to as a regulating unit.

The ability to keep the light intensity substantially constant in the plane in which the light-sensitive object is arranged, under variable degrees of illumination in the exit pupil, can be achieved by transmitting the light intensity signal received by the detector to the regulating unit. If the transmission of the illumination system or of the microlithography projection exposure apparatus changes due to a change in the illumination of the exit pupil plane caused by a setting adjustment or an adjustment of the degree of coherence of the illumination system, there can be a change of the light intensity in the plane in which the light sensitive object is arranged. However, the light intensity in the plane in which the light-sensitive object is arranged can also change as a result of fluctuations of the source intensity and as a result of degradation effects of the optical surfaces. At least the changes of the light intensity that are caused by fluctuations can be determined with the help of the detector. To provide a substantially constant light intensity in the plane in which the light-sensitive object is arranged, the so-called scanning speed can be varied or adjusted, i.e. the speed at which the object to be exposed, specifically the light-sensitive wafer, is moved in the image plane. For this adjustment, the intensity measured by the detector and possibly further information such as the setting that was made via an aperture stop for the illumination in the pupil plane, are taken into account in the regulating unit.

When there is a change in the transmission of the illumination system, the light quantity received by the wafer along the scanning path can be held constant through a regulation or control according to the foregoing description.

In some embodiments, the change of the illumination occurs via an aperture stop which is arranged in or near the exit pupil plane or a plane that is conjugate to the exit pupil plane.

Alternatively or additionally, an illumination system can be designed in such a way that the element serving to change the illumination is an exchangeable facetted optical element, for example a first facetted element with field facets in the case of a double-facetted illumination system with a first facetted element comprising field facets and a second facetted element comprising pupil facets as disclosed in U.S. Pat. No. 6,658,084, which is hereby incorporated by reference.

As a result of exchanging the first facetted element with field facets, the mutual assignment of field- and pupil facets to each other can be changed in the double-facetted illumination system, whereby the setting or the illumination in the exit pupil plane is changed as disclosed in U.S. Pat. No. 6,658,084. Alternatively or additionally, a change of the assignment and thus an adjustment of the illumination of the exit pupil plane can be achieved using individual field- and/or pupil facets are designed so that they can be tilted.

In certain embodiments, a table with control parameters for different setting adjustments is stored in the regulating unit. The table can contain calibration values which are obtained through measurements of the intensity distribution for example in the field plane and/or image plane with different illumination settings. As an example, an intensity value of 100 may be measured with a first setting, while an intensity value of 50 may be measured with a second setting. If the illumination changes from the first setting to the second setting, one cuts the scanning speed in half and ensures thereby that about the same dosage rate arrives in the image plane for both settings. A regulation which is performed during operation of the microlithography projection exposure apparatus via calibration tables or, alternatively, calibration curves, can be advantageous if more than two different illuminations or settings are realized. If only two setting positions are realized in a system, the regulation or control via a measurement of the difference can be performed during operation.

The expression “during operation” as used herein means that the regulation occurs while the light-sensitive object is being processed (e.g., during the exposure of the light-sensitive object).

The detectors configured to determine the current light intensity for example during the exposure process can be arranged in the light path before or after the device for setting the illumination in the exit pupil plane of the illumination system, such as in or near the exit pupil plane and/or a plane that is conjugate to the latter, and/or in or near the field plane of the illumination system and/or a plane that is conjugate to the latter. The detector can be arranged in the light path as well as outside of the light path. If the detector is arranged outside of the light path from the light source to the image plane, there is for example a mirror arranged in the light path which serves to shunt out a part of the light from the light path and direct it to a detector.

The disclosure also provides a microlithography projection exposure apparatus with this type of an illumination system as well as a method for setting an essentially constant level of light energy or integrated light energy along the scanning path in the image plane. It can be possible to adjust the integrated scan energy along a scanning path so that it always remains substantially the same under different illuminations. The integrated scan energy for a field height x along a path y in the image plane is defined as:

SE(x)=∫I(x,y)dy,

wherein I(x,y) represents the intensity of the light that is used for the exposure, i.e. the intensity of the usable radiation of e.g. 13.5 nm at a point x, y in the image plane. In other words, “integrated scan energy” means the total light energy to which a point on the light-sensitive substrate in the field plane of the projection exposure apparatus is exposed in the course of a scanning pass.

If the scan energy SE along a scanning path is for example SE(a1) before a change of the illumination, the method can have the result that the integrated scan energy SE(a2) after the change of the illumination is essentially equal to the integrated scan energy SE(a1), so that SE(a1)≈SE(a2). It can be advantageous if this applies equally to the integrated scan energies SE(a1) and SE(a2) at any field height x of the light-sensitive substrate in the image plane of the projection exposure apparatus.

In some embodiments, a method includes measuring the light energy prior to a change of the illumination in the exit pupil plane, and then measuring the light energy which is present after a change of the illumination, and to register a signal representing the difference. The difference signal, in turn, represents a measure for how strongly the scanning speed of the object to be illuminated and/or of the light-sensitive substrate needs to be changed in order to provide an essentially unchanged level of integrated light energy, in particular integrated scan energy, in the image plane of the microlithography projection exposure apparatus, even with a change in the illumination.

As an alternative (or in addition) to registering a difference signal, calibration values can be stored in the regulating unit. The calibration values can be obtained by measuring the intensity distribution with different illuminations or illumination settings. As an example, the calibration values can be stored in the form of a calibration table or a calibration curve. If an illumination setting is changed, the scanning speed of the light-sensitive substrate currently under exposure can be changed in accordance with the values that are stored as calibration values, whereby it can be ensured that even with different settings the dosage rate arriving in the image plane remains about the same.

In some embodiments, a projection exposure apparatus system can provide a relatively high scanning speed. This can be achieved, for example, without shunting light of the light source (e.g., so that substantially all of the light source is utilized). This can result in a relatively high throughput of a projection exposure apparatus. In certain embodiments, the system can provide a relatively continuous variation of the intensity (e.g., without entire pulses shunted out via, for example, a shutter).

In certain embodiments, the scanning speed can be adjusted to any desired value within a continuous range, whereby a continuous regulation can be achieved.

### BRIEF DESCRIPTION OF THE DRAWINGS

The disclosure is hereinafter described in detail through examples illustrated in the drawings, wherein:

FIG. 1 illustrates a shape of the field to be illuminated in the object plane.

FIGS. 2a and 2b illustrate illuminations in the pupil plane.

FIG. 3 is a schematic representation of an illumination system.

FIGS. 4a and 4b illustrate the number of light pulses falling on the object under exposure as a function of the scanning speed.

FIG. 5 illustrates a flowchart diagram for an example of the regulation.

### DETAILED DESCRIPTION

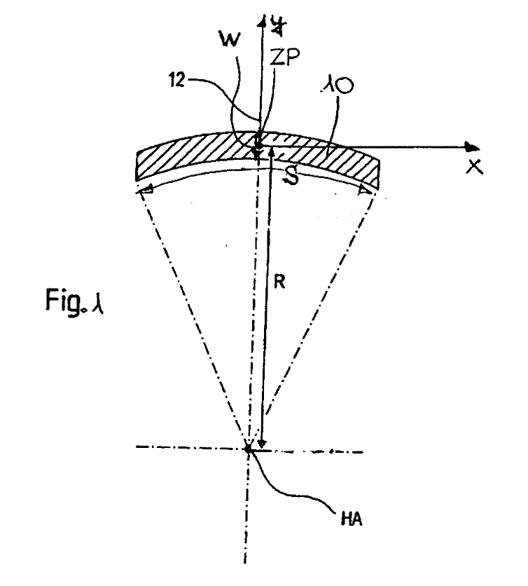

FIG. 1 illustrates the illuminated field in the field plane. The field is identified by the reference symbol 10. The field has an arcuate shape. The central field point ZP as well as the field radius R of the field 10 are indicated. The field radius R equals the distance from the optical axis HA of the projection objective. Also indicated in FIG. 1 are the arc length s and the local x/y/z-coordinate system whose origin lies in the central field point ZP of the field. The field 10 is formed in the field plane which is defined by the x- and y-directions. The illumination in the image plane has substantially the same shape as the illuminated field in the object plane. An image of the field that is illuminated in the object plane or field plane is projected into the image plane by a projection system or projection objective. If the projection system is a reducing system, a reduced image of the field in the object plane is projected into the image plane. For example in a 4:1 projection system, the field in the object plane or field plane is projected into the image plane as a 4-times reduced image. In the present embodiment, a mask in the object plane and/or the light-sensitive object in the image plane is moved along the y-direction. Accordingly, the y-direction is the so-called scanning direction of the microlithography projection exposure apparatus. Further indicated in the drawings is the scanning slot width w of the ring field which can be 1 mm (e.g., ≧2 mm) in the image plane of the microlithography projection exposure apparatus. Optionally, the ring field has a length x≈arc lengths ≧22 mm (e.g., ≧26 mm). The size of the scanning slot on the image side, i.e. the field size is for example 1×22 mm or 2×22 mm.

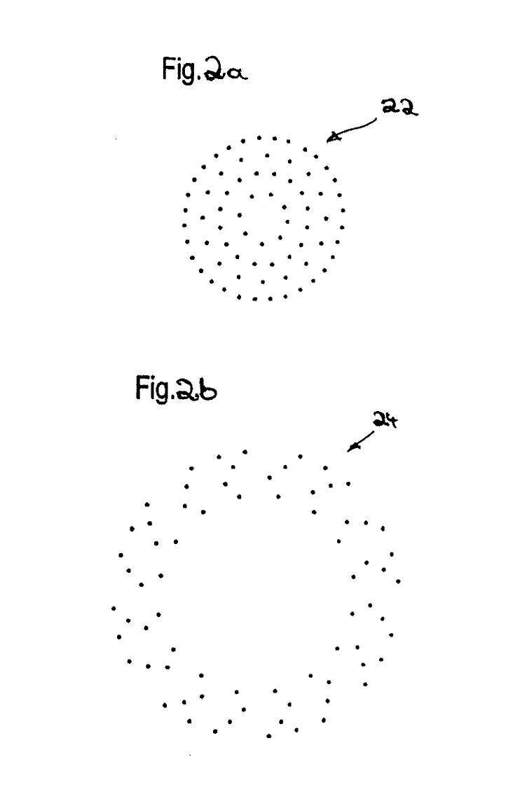

FIGS. 2a and 2b illustrate two different illuminations in the pupil plane of a microlithography projection exposure apparatus. FIG. 2a shows a first illumination 22 with a value σ=0.4 in the pupil plane or entry pupil in the case of a circular-shaped illumination of the second facetted element with raster elements, the so-called pupil facet mirror, and FIG. 2b shows an annular setting with the value of out

$$\frac{{σ}_{out}}{{σ}_{in}} = \frac{0 , 8}{0 , 4}$$

for a ring-shaped second illumination 24. An illumination of this kind can be set in an illumination system either by arranging an aperture stop directly before or in the vicinity of the second facetted element of a double-facetted illumination system, or by changing the mutual assignment between field-und pupil facets as described in U.S. Pat. No. 6,658,084.

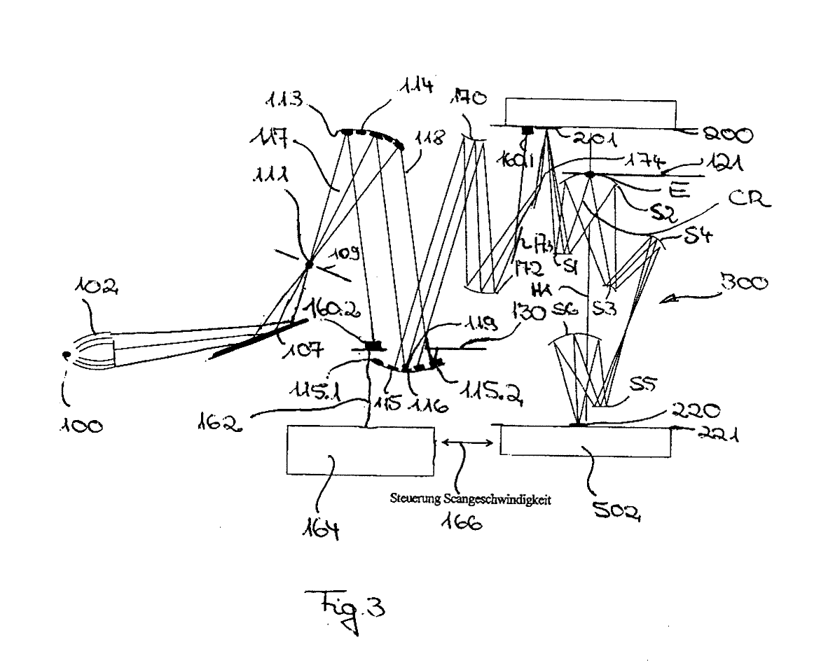

An illumination system is illustrated in FIG. 3 which is equipped with an element for changing the illumination of the exit pupil, i.e. the setting in the vicinity of the second facetted element. In the embodiment shown in FIG. 3, this element is an aperture stop 130.

The microlithography projection exposure apparatus according to FIG. 3 encompasses a light source 100 which emits light of a certain wavelength <100 nm (e.g., from 8 nm to 20 nm, from 11 and 14 nm, 13.5 nm). In some embodiments, the numerical aperture is from 0.2 to 0.3 at the wafer. The light emitted by the light source is gathered by the collector 102 which is configured as a grazing-incidence collector of the kind shown in WO 2002/27400, which is hereby incorporated by reference.

The radiation emitted by the light source is filtered through the spectral filter element 107 together with the aperture stop 109, so that only usable radiation of for example 13.5 nm wavelength is present behind the aperture stop. The spectral filter in the form of a grid element diffracts the light falling on the grid element in different directions, for example in the direction of 1^{st}-order diffraction. The aperture stop is arranged in or near the intermediate image 111 of the primary light source 100 in the direction of 1^{st}-order diffraction. The projection exposure apparatus further includes a first facetted optical element 113 with first facets, so-called field raster elements, which in catoptric systems are configured as small facet mirrors 114, and a second optical element 115 with second facets, so-called pupil raster elements or pupil facets, which in catoptric systems are likewise configured as facet mirrors 116. The field facets 114 or pupil facets 116 can be configured as planar facets and arranged as shown in a tilted position on a support element, or they can be configured as facets with optical power, for example positive or negative refractive power as shown in U.S. Pat. No. 6,198,793, which is hereby incorporated by reference. The first optical element 113, which includes the field facets, divides the light bundle 117 arriving from the primary light source 100 into a multitude of light bundles 118. Each of the light bundles 118 is being focused and forms a secondary light source 119 at or near the location where the second optical facetted element 115 with pupil raster elements is arranged.

In the microlithography projection exposure apparatus illustrated in FIG. 3 the illumination in the exit pupil plane 121 in which the exit pupil of the illumination system is located is adjusted through the concept whereby, before the second facetted element, i.e. the pupil facet element, an aperture stop 130 is arranged which allows certain pupil facets 115, for example the pupil facet 115.1 in FIG. 3, to be selectively blocked out. In this way it is very easy to adjust an illumination with different coherence values, so-called σ-values. Alternatively, it is also possible to adjust individual pupil facets for the formation of more complex structures such as for example a quadrupolar or dipolar illumination via the aperture stop arrangement 130 which is placed before the second facetted optical element. This is also referred to as a setting adjustment. As an alternative to adjusting the degree of coherence via the illustrated aperture stop 130, it would also be possible to make an adjustment through a change in the assignment of the light channels from the field facet elements to the pupil facet elements.

An adjustment of an illumination in the exit pupil plane 121 via such a change in the assignment is described in U.S. Pat. No. 6,658,084.

The change of the transmission that occurs as a result of fluctuations of the light source or from putting in the aperture stop 130 for the adjustment of the illumination in the exit pupil plane 121 can be registered via at least one detector 160.1. In the illustrated case, the detector 160.1 is arranged in the light path after the element that serves to change the illumination in the pupil plane, in this case the aperture stop 130. In concrete terms, the detector 160.1 in the present case is arranged in the object plane 200 of the projection objective that follows downstream in the light path. This arrangement is intended to serve only as an example. The detector can be arranged relative to the light path from the light source to the object plane also before the device for changing the illumination, as is the case for the detector 160.2, or it can be arranged on the device for changing the illumination. The incident light arriving from the field facets is reflected at the pupil facet 115.2 and directed to the detector 160.1 which in relation to the light path lies after the second facetted optical element 116. While in the present embodiment the detector 160.2 within the overall light path from the light source to the image plane lies primarily in the light path section from the first facetted element 113 to the second facetted element 116, the detector 160.1 is arranged outside of the light path from the light source to the image plane. The light for the detector 160.1 in the present case is shunted out of the light path by way of a shunt-out mirror 173. However, it would also be conceivable to arrange the detector 160.1 within the light path. It is also possible to place detectors at locations other than those shown here, in particular for example in a conjugate plane of the exit pupil plane 121 or of a field plane that coincides with the object plane 200. Furthermore, the measurement can in this case likewise be performed with one detector or with a plurality of detectors. Depending on where the detector is placed, different light signals are received by the detector. If for example the detector 160.1 is arranged in the light path after the aperture stop 130, i.e. after the device for adjusting the setting, there will be different light signals resulting from different settings. The light received by the detector 160.1 can be used in this case directly as a control signal or as a regulation signal 162 for a regulation/control unit 164 for adjusting the scanning speed as a function of the setting. If on the other hand the detector is arranged in the light path before or on the aperture stop itself which serves to adjust the setting, as is the case for the detector 160.2, only intensity fluctuations coming for example from the source 100 can be registered. With this kind of a signal, the scanning speed 166, for example of a carrier 168 for the object under exposure such as for example a wafer, can be adapted only to these intensity fluctuations. If in addition one wants to adjust the scanning speed also to the current setting, there needs to be additional information, for example the position of the aperture stop that controls the setting. With this additional information, the regulating unit 169 can also regulate the scanning speed appropriately for different settings with a detector 160.2 which is arranged in the light path before the device for the adjustment of the setting. In the illustrated embodiments, two detectors 160.1 and 160.2 are provided, wherein a first detector 160.1 for the detection of the setting is arranged in the light path downstream of the device for adjusting the setting, and a further, second detector 160.2 for detecting intensity fluctuations for example of the light source is arranged in the light path before the device for adjusting the setting. Based on the signals of these two detectors 160.1, 160.2, the scanning speed can be regulated in accordance with intensity fluctuations and settings.

As explained above, a change of the light transmission, for example when the setting is changed from σ=0.8 to σ=0.5, causes a geometric light loss of 60%. This change can be compensated, and it can thus be ensured that there is always the same quantity of light falling on the object under exposure in the image plane. This can be achieved for example by adjusting the scanning speed of the wafer, i.e. of the substrate under exposure in the image plane, dependent on the light signal received by the detector 160.2 and/or detector 160.1 and possibly dependent on additionally received information for example about the position of the aperture stop for adjusting the setting, so that the light quantity falling on the substrate under exposure in the image plane always remains substantially the same. This can ensure that a substantially uniform exposure is maintained during the exposure process even when the transmission changes as a result of a setting change and/or as a result of fluctuations of the light intensity.

The illustrated example of an embodiment shows in addition in the light path downstream of the second facetted optical element, i.e. of the pupil facet mirror 116, two normal-incidence mirrors 170, 172 and a grazing incidence mirror 174 serving to project an image of the pupil facets onto an entry pupil E of the projection objective and to form a field in the object plane 200.

If the field raster elements have the shape of the field to be illuminated, it is not necessary to provide a mirror for the shaping of the field.

The entry pupil E of the projection objective which coincides with the exit pupil in the exit pupil plane 121 of the illumination system is given by the point of intersection of the optical axis HA of the projection objective with the principal ray CR through the central field point Z of the field shown in FIG. 1, which is reflected at the reticle.

In the object plane 200 of the microlithography projection exposure apparatus, a reticle is arranged on a transport system. The reticle which is arranged in the object plane 200 is projected via the projection objective 300 into an image on a light-sensitive substrate 220, specifically on a wafer. The wafer or substrate is arranged substantially in the image plane 221 of the projection objective. The uniform exposure of the light-sensitive substrate is ensured by the regulating unit 164 which adjusts the scanning speed of the support system 502 on which the wafer is arranged, dependent on the light signal received by the detector 160.1, 160.2.

The illustrated projection objective includes six mirrors, i.e. a first mirror S1, a second mirror S2, a third mirror S3, a fourth mirror S4, a fifth mirror S5, and a sixth mirror S6, which are arranged in centered alignment around a common optical axis HA. The projection objective has a positive back focus. This means that the principal ray CR belonging to the central field point, which is reflected by the object 201 in the object plane, enters the projection objective in a direction towards the object 201. The point of intersection of the optical axis HA of the objective with the principal ray CR belonging to the central field point, which is reflected at the reticle, determines the location of the entry pupil E of the illumination system, which coincides with the exit pupil of the illumination system which lies in the exit pupil plane 121 of the illumination system. Through the aperture stop 130 or by changing the assignment of field facets to pupil facets, the illumination in the exit pupil plane, i.e. in the entry pupil plane E of the projection objective is changed, i.e. the setting in that location is adjusted. An aperture stop B which can also be configured to be variable is arranged in the area of the entry pupil E of the projection objective.

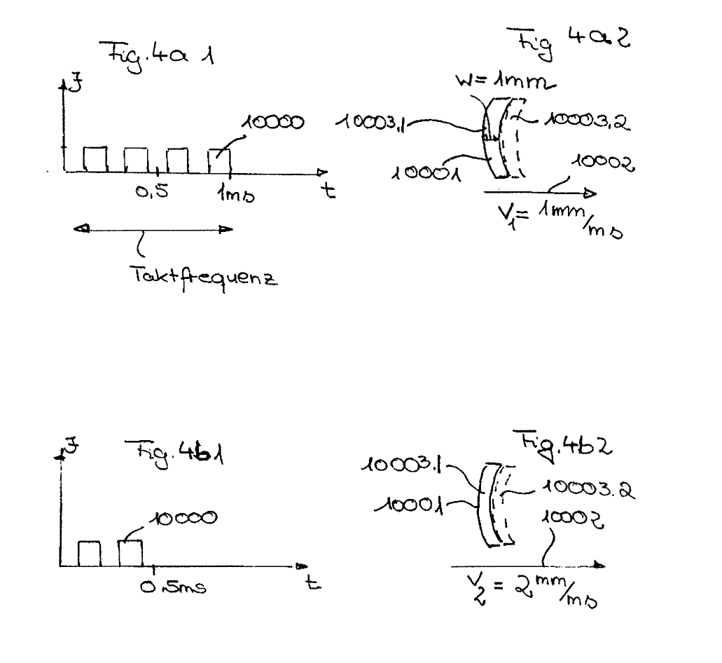

If the detector 160.2 is arranged in the light path downstream of an aperture stop 130 for the adjustment of the setting, the light signal received by the one or more detectors 160.2 is transmitted to a regulating unit 164. In the regulating unit 164, the light signal received is compared for example to reference values or calibration values of a calibration table or a calibration curve and the scanning speed is set accordingly. The calibration values can be registered for example with the help of a detector which can be arranged in the image plane 221, i.e. in the wafer plane, for acquiring the calibration values. The values obtained for different settings are stored in the table. The values actually measured in operation by the detector 160.2 are compared to the calibration values and the scanning speed is regulated accordingly. If the value is 100 for a first setting and 50 for a second setting, the same amount of light is provided in the image plane, i.e. on the wafer, if the scanning speed v₂ is essentially half as fast for the second setting as the scanning speed v₁ for the first setting. Alternatively, the detector 160.1 can be arranged directly on the aperture stop 130 for adjusting the setting, or upstream of the aperture stop 130 in relation to the path of light propagation. In this case, the detector will always receive substantially the same quantity of light independent of the setting. Only intensity fluctuations of e.g. the light source 100 still have an influence on the intensity signal. If the intensity signal is transmitted to the regulating unit, it is possible via the regulating unit to compensate the intensity fluctuations registered by the detector by varying the scanning speed. If in an arrangement of this type additional information such as the position of the aperture stop for the adjustment of the setting is made available, it is also possible to adapt the scanning speed to the setting. The following FIGS. 4a and 4b serve to illustrate with greater clarity the effects from a change of the scanning speed on the light intensity which occurs per unit of time in the image plane.

In a clock-pulsed light source as described for example in US 2005/110972 A, which is hereby incorporated by reference, the number of light pulses emitted per unit of time is substantially constant and the light intensity is the same for each light pulse. In the embodiment according to FIG. 4a.1 the frequency is for example 4 pulses per millisecond. If the scanning slot 10001 shown in FIG. 4a.2 with a scanning slot width of 1 mm is moved with a speed v₁₌₁ mm/ms in the y-direction, i.e. in the scanning direction 10002, from the position 10003.1 to the position 10003.2, there will be four light pulses 10000 falling on the object under exposure in the image plane. The calibration value that was determined based on the setting for the embodiment according to FIG. 4a.1 is for example 50. If the setting is changed so that the calibration value is 100 for the case shown in FIGS. 4b.1 and 4b.2, the number of light pulses falling on the image plane needs to be cut in half for the incident light quantity to be the same as in FIGS. 4a.1 and 4a.2. This is achieved by doubling the scanning speed to v₂=2 mm/ms. Instead of 4 pulses there are only 2 light pulses falling on the substrate under exposure at a pulse frequency of 4 pulses per millisecond.

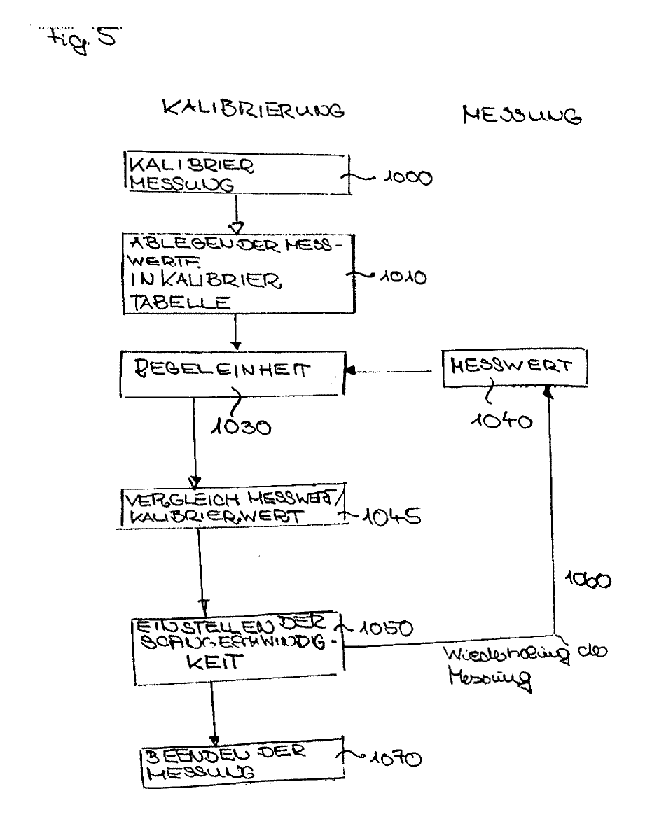

FIG. 5 represents a flowchart diagram for an example of the regulation.

The flowchart shown in FIG. 5 represents one possibility, how the measurement signals received by the detector can be used for controlling the scanning speed of a light-sensitive object in an image plane. As described above, a first step is to make a calibration measurement 1000 for different settings, i.e. different adjustments of the illumination in the plane. The values of the calibration measurement are stored for example in calibration tables in the regulating unit. This is described under step 1010 which occurs after the calibration of the regulating unit is completed for example by performing an empty measurement, i.e. a measurement in a condition where the illumination system of a microlithography projection exposure apparatus is not used for the exposure of a light-sensitive object or wafer, but is measured empty. This condition is also referred to as non-operating condition.

The calibration values registered during the empty measurement are stored in the regulating unit. If the illumination system is subsequently uses in a microlithography projection exposure apparatus for the exposure of a light-sensitive wafer, a specific setting adjustment is made, i.e. an adjustment of the illumination in the pupil plane. Based on the light intensity detected by a detector and possibly based on additional factors such as aperture stop settings of the aperture stop that controls the setting, which are transmitted to the regulating unit, the speed at which the object under exposure in the image plane needs to be moved is determined on the basis of the calibration table.

The regulating unit is identified by the reference symbol 1030. The detector acquires the measurement signal in a step 1040 and transmits the measurement signal to the regulating unit 1030. In the regulating unit a comparison is made in step 1045 based on the calibration table, and based on this comparison the scanning speed, which represents the quantity being regulated, is transmitted in a step 1050 by the regulating unit for example to a stepper motor which determines the speed of advancement of the moving stage on which the object under exposure is arranged. Subsequent to step 1050, the measurement is repeated in intervals (step 1060) or terminated (step 1070).

As an alternative to the foregoing method which finds application in particular if more than two settings are possible, i.e. if an aperture stop allows for example a continuous adjustment of illuminations in the pupil plane, it is possible in a system with only two settings to control the scanning speed through a differential measurement. Thus, an optimal scanning speed is determined first under a first illumination of the exit pupil. A first light intensity is measured in this step. If the illumination is subsequently changed, the signal measured by the detector for the light intensity will change if the detector is arranged in the light path after the adjusting device. Based on a differential signal representing the difference in the illumination before and after the change, it is possible to determine the amount by which the scanning speed needs to be changed in order to ensure the same exposure result after the change in the illumination as was obtained under the first illumination. If for example the illumination is reduced by 50% by the change in the setting, the scanning speed needs to be reduced likewise by 50% relative to the scanning speed under the first illumination in order for the object under exposure to receive the same light quantity as in the case of the first illumination. If the detector is arranged in the light path before the arrangement by which the illumination, i.e. the setting is adjusted, additional information will be required besides the detected light signal, for example data concerning the aperture stop setting, in order to set the scanning speed in the plane of the object under exposure.

In some embodiments, the disclosure provides a device and/or method in which the light of the light source can be utilized completely and/or in which nevertheless the object under exposure is always receiving substantially the same amount of light when the illumination in the pupil plane changes due to setting adjustments or intensity fluctuations.

Other embodiments are in the claims.

What is claimed is:

1. An illumination system having an exit pupil plane, the illumination system configured to pass light therethrough during use, the illumination system comprising:
an element configured so that, during use, the element can change a first illumination in the exit pupil plane to a second illumination;
a detector configured so that, during use, the detector can detect the light;
a device configured so that, during use, the device receives a light intensity signal of the detector,
wherein:
the illumination system is configured to be used in a microlithography projection exposure apparatus; and
dependent on the light intensity signal, the device produces a signal that can be used to adjust a scanning speed of a light-sensitive object in an image plane of the microlithography projection exposure apparatus.

2. The illumination system according to claim 1, further a comprising a light source configured to produce the light.

3. The illumination system according to claim 2, wherein the light has a wavelength of about 100 nm or less.

4. The illumination system according to claim 1, wherein the detector is arranged so that, when the illumination system is incorporated in a microlithography exposure apparatus having a light source, the detector is between the light source and the exit pupil plane in a light path of the light traveling from the light source to the exit pupil plane.

5. The illumination system according to claim 1, wherein during use the device receives a first setting signal representing a first setting of the element, and with the first setting a first illumination is made available.

6. The illumination system according to claim 3, wherein during use the device receives a second setting signal representing a second setting of the element, and with the second setting a second illumination is made available.

7. The illumination system according to claim 1, wherein the device comprises a regulating unit including a memory storage unit in which at least a first calibration value for a first illumination and a second calibration value for the second illumination are stored.

8. The illumination system according to claim 7, wherein the memory storage unit has a calibration table in which a plurality of calibration values are stored.

9. The illumination system according to claim 7, wherein during use the element continuously adjusts an illumination in the exit pupil plane, and a calibration curve is stored in the memory unit.

10. The illumination system according to claim 1, wherein the scanning speed determines the speed of advancement of a scanning stage on which the light-sensitive object can be arranged.

11. The illumination system according to claim 10, wherein the light-sensitive object is a wafer.

12. The illumination system according to claim 1, wherein the element comprises an aperture stop.

13. The illumination system of claim 12, wherein the aperture stop is arranged in or near the exit pupil plane or a conjugate plane of the exit pupil plane.

14. The illumination system according to claim 1, wherein the element comprises an exchangeable facetted optical element.

15. The illumination system according to claim 1, wherein the element comprises an exchangeable facetted optical element with a large number of facet mirrors whose position can be changed.

16. The illumination system according to claim 1, wherein the detector is arranged so that, when the illumination system is incorporated in a microlithography exposure apparatus having a light source, the detector is in a light path from the light source to the exit pupil planedownstream of the element serving to change the illumination.

17. The illumination system according to claim 1, wherein the detector is arranged so that, when the illumination system is incorporated in a microlithography exposure apparatus having a light source, the detector is in the light path from the light source to the exit pupil plane upstream of the element.

18. The illumination system according to claim 1, wherein the detector is arranged at or near the element.

19. The illumination system according to claim 1, wherein the detector is arranged so that, when the illumination system is incorporated in the microlithography projection exposure apparatus, the detector is at or near an object plane or in the image plane of the microlithography projection exposure apparatus.

20. The illumination system according to claim 1, wherein the illumination system is a catoptric illumination system.

21. The illumination system according to claim 1, wherein the illumination system comprises a facetted optical element.

22. The illumination system according to claim 21, wherein the facetted optical element comprises a large number of facet mirrors.

23. A system, comprising:
an illumination system according to claim 1, the illumination system having an object plane; and
a projection objective having an image plane, the projection objective being configured to project an image of an object arranged in the object plane into the image plane,
wherein the system is a microlithography exposure apparatus.

24. The system according to claim 23, wherein the projection objective comprises an aperture stop.

25. A method, comprising:
measuring a light energy in an illumination system that is incorporated in a microlithography projection exposure apparatus;
changing the illumination in a pupil plane of the illumination system;
after changing the illumination in the pupil plane of the illumination system, measuring a light energy in the illumination system;
forming a differential signal that represents a difference in light energy measured before and after the change of the illumination in the pupil plane of the illumination system; and
based on the differential signal, setting a scanning speed of a light sensitive object in the image plane of a projection objective that is incorporated in the microlithography projection exposure apparatus.

26. The method according to claim 25, wherein the light has a wavelength of about 100 nm or less.

27. The method according to claim 25, wherein the differential signal is received continuously and delivered to a regulating unit, and that the scanning speed of the light-sensitive object in the image plane is adjusted continuously.

28. A method, comprising:
providing a first set of measured values by measuring a light energy for different illuminations in an exit pupil plane of an illumination system that is incorporated in a microlithography projection exposure apparatus;
storing the first set of measured values as calibration values in a regulating unit;
after storing the calibration values, forming a second set of measured values by measuring the light energy via a detector;
comparing the second set of measured values to the stored calibration values; and
based on the comparison, adjusting a scanning speed of a light-sensitive object in an image plane of a projection objective that is incorporated in the microlithography projection exposure apparatus.

29. The method according to claim 28, wherein the calibration values are stored in the form of a calibration table and/or a calibration curve.

30. The method according to claim 25, wherein a detector is arranged at or near an element that serves to change the setting of the illumination of the pupil plane.

31. The method according to claim 25, wherein the microlithography projection exposure apparatus has an object plane and an image plane, and a detector is arranged at or near the object plane and/or the image plane.
